(19) United States
(12) Patent Application Publication
(10) Pub. No.: US 2026/0080599 A1
(43) Pub. Date: Mar. 19, 2026

(54) INFORMATION PROCESSING APPARATUS, INFORMATION PROCESSING METHOD, AND COMPUTER-READABLE NON-TRANSITORY STORAGE MEDIUM

(71) Applicant: SONY GROUP CORPORATION, Tokyo (JP)

(72) Inventor: Hiroki MIZUNO, Tokyo (JP)

(21) Appl. No.: 19/106,643

(22) PCT Filed: Aug. 29, 2023
(86) PCT No.: PCT/JP2023/031245

§ 371 Date: Feb. 26, 2025

(30) Foreign Application Priority Data
Sep. 6, 2022 (JP) 2022-141716

(51) Int. Cl. G06T 13/40; G06T 7/246; G06T 7/33; G06T 7/73; G06T 17/20; G06T 19/20

(52) U.S. Cl. CPC G06T 13/40; G06T 7/246; G06T 7/344; G06T 7/73; G06T 17/20; G06T 19/20; G06T 2207/20081; G06T 2207/30201; G06T 2207/30204; G06T 2219/2004; G06T 2219/2021

(57) ABSTRACT

The information processing apparatus includes a first deformation execution unit and a second deformation execution unit. The first deformation execution unit deforms a face model of an actor on the basis of positions of a plurality of markers in a face image of the actor to which the plurality of markers are attached, and generates a first deformed face model. The second deformation execution unit deforms a shape of a low reproduction portion of the first deformed face model based on the face image of the actor so that a position of a contour of the low reproduction portion having relatively low reproducibility in the first deformed face model matches a position of a contour of the low reproduction portion in the face image of the actor, and generates a second deformed face model.

### FIELD

The present invention relates to an information processing apparatus, an information processing method, and a computer-readable non-transitory storage medium.

### BACKGROUND

As a method for realizing real Facial Animation by computer graphics (CG), a method constructed from two processes of rigging for constructing a mechanism for moving a face and animation for giving an expression to a CG character is most widely used. However, both processes require manual work by an artist, and in particular, it is necessary to repeat many trials and errors in order to reproduce the real person so realistically that the real person cannot be distinguished from the real person.

### CITATION LIST

### Patent Literature

Patent Literature 1: JP 2013-054761 A

### SUMMARY

### Technical Problem

On the other hand, there is also a method for realizing Facial Animation by directly deforming the polygon mesh of the face of the CG character from the motion of the face of the actor. In this method, the motion of the marker attached to the face of the actor is acquired by motion capture, and the motion information is directly applied to the polygon mesh to realize Facial Animation. This method can realize a high-quality animation at low cost as compared with the method of constructing a facial rig, but cannot move a portion to which a marker is not attached. Therefore, such a portion is a low reproduction portion in which it is difficult to reproduce the motion of the face of the actor.

Therefore, the present disclosure proposes an information processing apparatus, an information processing method, and a computer-readable non-transitory storage medium capable of reproducing motion of a face of an actor in high quality.

### Solution to Problem

According to the present disclosure, an information processing apparatus is provided that comprises: a first deformation execution unit that deforms a face model of an actor on a basis of positions of a plurality of markers in a face image of the actor to which the plurality of markers are attached, and generates a first deformed face model; and a second deformation execution unit that deforms a shape of a low reproduction portion of the first deformed face model on a basis of the face image of the actor so that a position of a contour of the low reproduction portion having relatively low reproducibility in the first deformed face model matches a position of a contour of the low reproduction portion in the face image of the actor, and generates a second deformed face model. According to the present disclosure, an information processing method in which an information process of the information processing apparatus is executed by a computer, and a computer-readable non-transitory storage medium which stores a program for causing the computer to execute the information process of the information processing apparatus, are provided.

### BRIEF DESCRIPTION OF DRAWINGS

FIG. 1 is a diagram for explaining an outline of a video production system.

FIG. 2 is a diagram illustrating an example of installing a marker on an eyelid.

FIG. 3 is a diagram for explaining alignment processing.

FIG. 4 is a diagram illustrating an example of a processing flow of alignment processing.

FIG. 5 is a diagram illustrating an example of a region on a face model to be a target of cost calculation.

FIG. 6 is a diagram illustrating an example of a region on a face model to be a target of cost calculation.

FIG. 7 is a diagram illustrating an example of a region on a face model to be a target of cost calculation.

FIG. 8 is a diagram illustrating an example of a region on a face model to be a target of cost calculation.

FIG. 9 is a diagram illustrating an example of a region on a face model to be a target of cost calculation.

FIG. 10 is a diagram illustrating an example of a processing flow of second deformation processing.

FIG. 11 is a diagram illustrating a generation example of learning data.

FIG. 12 is a diagram illustrating an example of a Feature Graph.

FIG. 13 is a diagram illustrating an example of a processing flow of third deformation processing.

FIG. 14 is a diagram illustrating a processing example.

FIG. 15 is a diagram illustrating a processing example.

FIG. 16 is a diagram illustrating an example of a hardware configuration of an information processing apparatus.

### DESCRIPTION OF EMBODIMENTS

Hereinafter, embodiments of the present disclosure will be described in detail with reference to the drawings. In the following embodiments, the same portions are denoted by the same reference numerals, and redundant description will be omitted.

Note that the description will be given in the following order.
[1. Video production system]
   [1-1. Marker position acquisition unit]
   [1-2. Contour position detection unit]
   [1-3. Alignment execution unit]
   [1-4. First deformation execution unit]
   [1-5. Second deformation execution unit]
   [1-6. Third deformation execution unit]
[2. Processing example]
[3. Hardware configuration example]
[4. Effects]

### 1. Video Production System

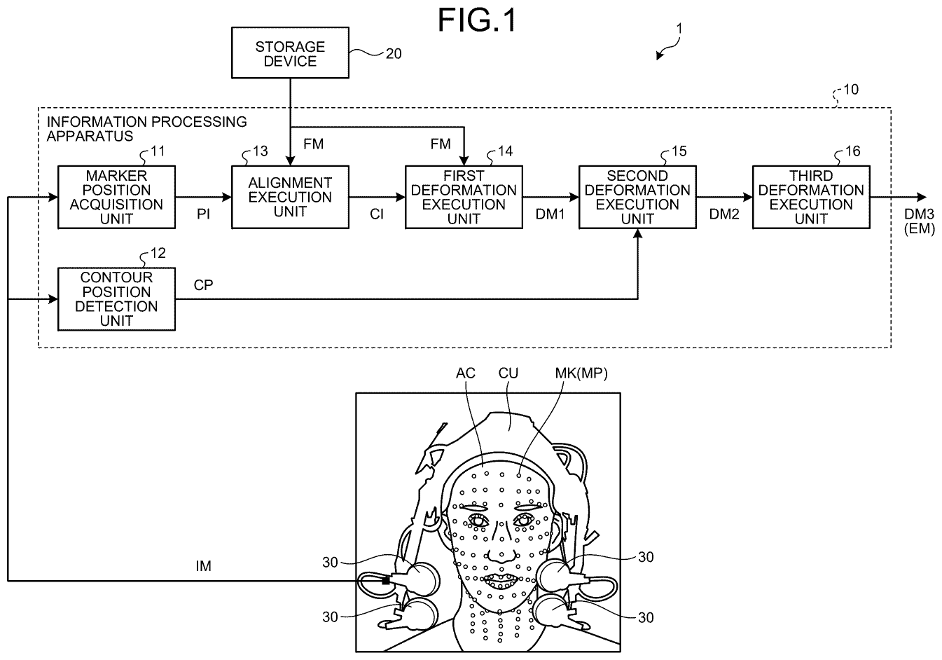

FIG. 1 is a diagram for explaining an outline of a video production system 1.

The video production system 1 is a system that produces a digital human using a facial marker tracking technology. The video production system 1 tracks the motion of a marker MK attached to the face of an actor AC. A plurality of marker points MP indicating installation positions of the markers MK are set in advance on the face of the actor AC. The video production system 1 generates the expression of the actor AC on the basis of the relative motion between the markers MK (parts of the face defined as the marker points MP).

Note that, in the present disclosure, an actor is not limited to a professional performer, and may include a general user. It should be noted that, in the present disclosure, an actor is a general term of a user who uses a system for providing a digital human, and is not a term representing a user who executes a specific purpose using the digital human.

The video production system 1 acquires a face model FM of a CG character as a base. The video production system 1 generates an expression model by applying the generated expression to the face model FM. In the example of FIG. 1, the face model FM of the actor AC is used as the face model of the CG character, but the generated expression may be applied to the face model of another CG character.

A camera unit CU for photographing the actor AC is attached to the head of the actor AC on which the marker MK is installed. For example, a plurality of cameras 30 in which visual fields are partially superimposed are fixed to the camera unit CU. The camera unit CU photographs the entire installation region of the marker MK using the plurality of cameras 30. The plurality of cameras 30 are synchronously driven and monitor the motion of each marker MK.

The motion of the marker point MP is detected as the motion of the marker MK. The motion of the face is generated based on the change in the positional relationship between the plurality of marker points MP. In order to accurately reproduce the motion of the face, it is necessary to track the motion of the marker point MP with high accuracy. However, the motion of the marker point MP cannot be accurately detected for a portion where it is difficult to install the marker MK or a motion where the marker MK is hidden due to the motion of the face. Such a portion is a low reproduction portion that hardly reproduces the motion of the face of the actor AC.

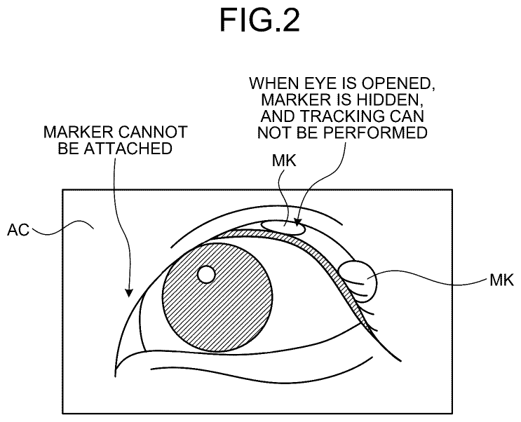

FIG. 2 is a diagram illustrating an example of installing a marker MK on an eyelid.

The marker MK is configured as, for example, a seal-shaped high reflectance member. The actor AC attaches the marker MK to the marker point MP set on the eyelid. However, since the eyelid is small, it is difficult to paste the marker MK. Even if the marker MK can be installed on the eyelid, it is difficult to accurately track the marker MK because there is a possibility that the marker MK is hidden when the eye is opened. Therefore, the eyelid is a low reproduction portion with a low degree of reproduction of the shape. Such a problem may occur not only on the eyelid but also on the mouth or the like.

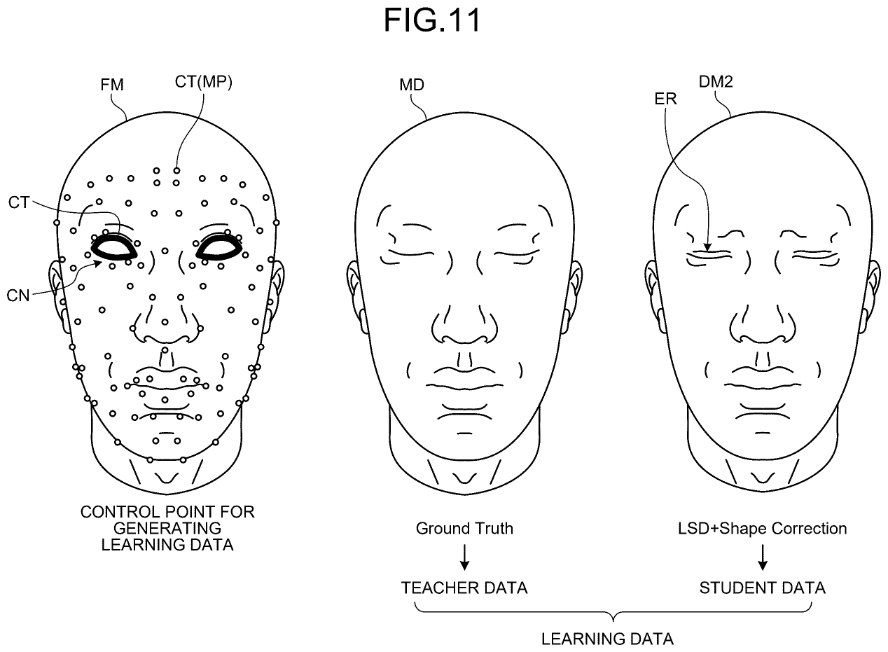

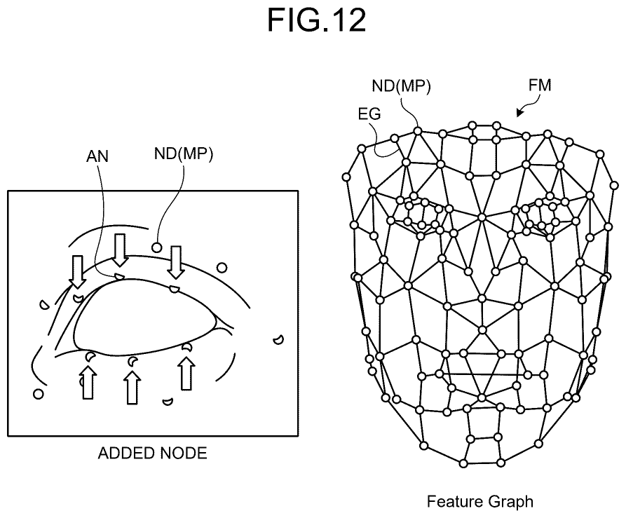

Therefore, in the present disclosure, the actor AC is photographed by the camera 30, and the contour CN (see FIG. 11) of the low reproduction portion such as the eyelid is detected from the photographed image. Then, the shape of the low reproduction portion is deformed using the information of the detected contour CN. The deformation of the shape of the portion other than the low reproduction portion is performed using the information of the marker MK. As a result, the motion of the entire face can be reproduced with high quality. Details will be described below.

Returning to FIG. 1, the video production system 1 includes an information processing apparatus 10, a storage device 20, and a camera 30. The camera 30 is fixed in front of the actor AC as an installation target of the marker MK. While installation work of the marker MK is being performed, the camera 30 photographs the face of the actor AC at a predetermined frame rate, and sequentially outputs the face image IM of the actor AC to the information processing apparatus 10.

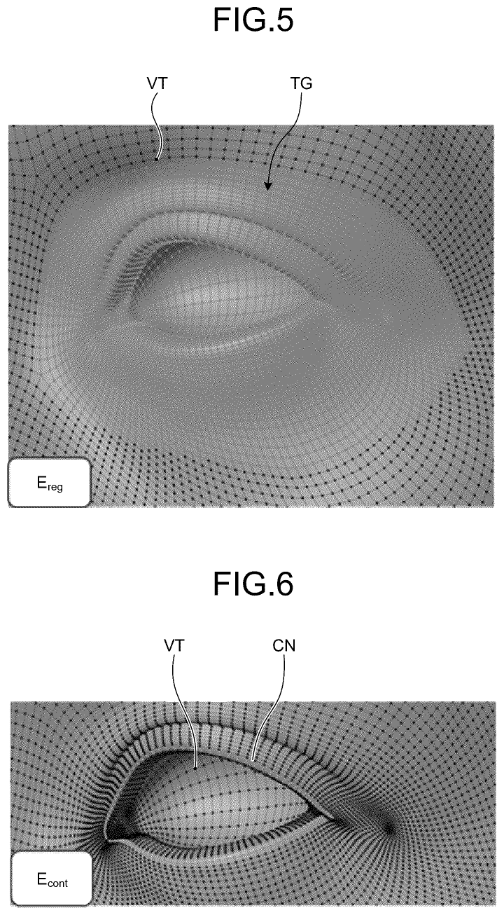

The storage device 20 stores information of the face model FM of the actor AC. The face model FM is a three-dimensional model of the face of the actor AC. The expression of the face model FM is, for example, expressionless. The face model FM is created by general CG software. For example, the face of the face model FM includes polygon meshes. The polygon mesh includes a plurality of vertices VT (see FIG. 5), and a plurality of sides and a plurality of surfaces obtained by connecting adjacent vertices VT.

The face model FM includes position information of a point cloud (vertex VT of the polygon mesh) indicating the shape of the face and position information of marker points MP. The positions of the marker points MP are individually determined according to the shape of the face of the actor AC. The marker points MP are set substantially uniformly on the entire face. For example, the marker point MP is set based on a specific vertex VT of the polygon mesh.

The information processing apparatus 10 detects the marker MK and the contour CN of the low reproduction portion from the face image IM of the actor AC photographed by the camera 30. The information processing apparatus 10 deforms the face model FM on the basis of the detected marker MK and the position information of the low reproduction portion. The information processing apparatus 10 includes, for example, a marker position acquisition unit 11, a contour position detection unit 12, an alignment execution unit 13, a first deformation execution unit 14, a second deformation execution unit 15, and a third deformation execution unit 16.

### [1-1. Marker Position Acquisition Unit]

The marker position acquisition unit 11 acquires three-dimensional positions of a plurality of markers MK attached to the face of the actor AC from the face image IM of the actor AC. The marker position acquisition unit 11 outputs the position information of the plurality of measured markers MK as measured position information PI.

In order to acquire the position of the marker MK, a known motion capture system or a facial capture system using a head-mounted camera can be used. In the example of FIG. 1, a compound-eye head-mounted camera equipped with a plurality of cameras 30 is used as the camera unit CU. When the position of the marker MK is acquired by the head-mounted camera, since the camera 30 and the head are fixed, the marker position acquisition unit 11 can acquire the three-dimensional position of the marker MK that does not depend on the motion of the head.

In a case where the motion capture system is used to acquire the position of the marker MK, the acquired three-dimensional position is a position on the world coordinate system, and thus is a position including the movement of the head. In order to realize Facial Animation, it is necessary to cancel the motion of the head in order to acquire only the motion of the face portion. Therefore, by installing a marker for head position estimation on the head, obtaining 6DoF (translation/rotation parameter) of the head by a motion capture system, and applying an inverse matrix of the obtained 6DoF to the position of the marker MK, it is possible to acquire the position of the marker MK in which the motion of the head is canceled.

### [1-2. Contour Position Detection Unit]

The contour position detection unit 12 detects the position of the contour CN of the low reproduction portion from the face image IM of the actor AC. The contour position detection unit 12 outputs the position information of the contour CN of the low reproduction portion as contour position information CP. A known landmark detection technique can be used to detect the contour CN. For example, the contour position detection unit 12 detects a characteristic point serving as a mark as a landmark from the face image IM of the actor AC. The contour position detection unit 12 specifies the position of the contour CN of the low reproduction portion in the face image IM of the actor AC based on the positions of one or more landmarks extracted from the face image IM of the actor AC.

For the detection of the landmark, it is possible to use a landmark detector using a deep learning technique like OpenFace (refer to Document 1 below) which is an open source software, or use a contour detector specialized for an actor AC. For construction of a contour detector specialized for an actor AC, use of a random ferns shape regressor (see the following Document 2) capable of constructing a detector from a relatively small amount of learning data, and the like can be considered.
[Document 1] [online], [searched on Jul. 13, 2022], Internet <URL: https://github.com/TadasBaltrusaitis/OpenFace>
[Document 2] “Face Alignment by Explicit Shape Regression”, CVPR 2021

### [1-3. Alignment Execution Unit]

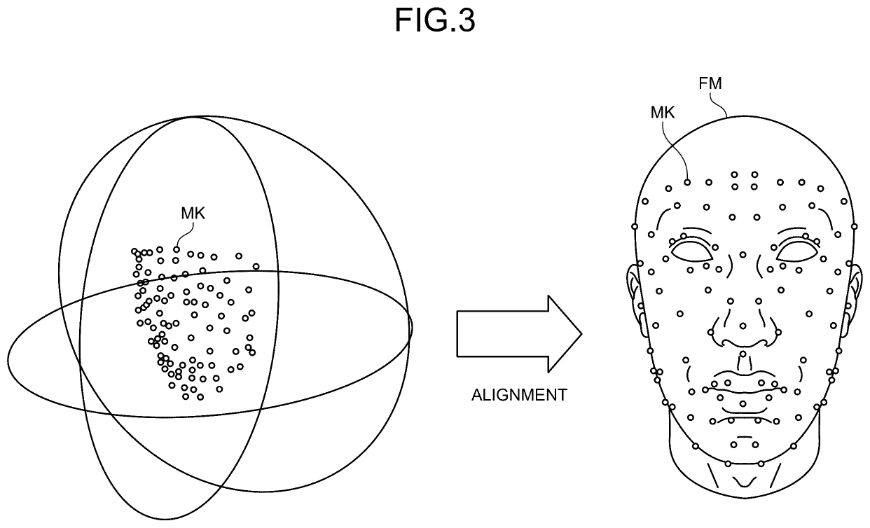

FIG. 3 is a diagram for explaining alignment processing.

The alignment execution unit 13 aligns the plurality of markers MK detected by the marker position acquisition unit 11 with the face model FM. The position of the marker MK defined in the measured position information PI is represented by a coordinate system (system coordinate system) of the motion capture system or the facial capture system. Therefore, the alignment execution unit 13 converts the position (coordinates) of each marker MK expressed in the system coordinate system into a position expressed in the coordinate system (model coordinate system) of the face model FM.

For example, an iterative closet point (ICP) is used for coordinate conversion. ICP is an algorithm for alignment between two different pieces of shape data. In the ICP, rigid body deformation (translation, rotation, and enlargement) can be handled, but non-rigid body deformation such as a difference in expression cannot be handled. Therefore, it is desirable that the actor AC make the same expression as the expression of the face model FM and align the plurality of markers MK with the face model FM using the measured position information PI acquired at that time. The expression used for the alignment is typically a neutral expression (expressionless).

It is difficult to completely match the expression of the actor AC with the expression of the face model FM. Therefore, as a result of the alignment, some positional deviation (residual) may remain. The alignment execution unit 13 acquires the distribution of the positional deviation between each marker MK and the face model FM as the residual distribution. The alignment execution unit 13 corrects the position (coordinates) of each marker MK based on the residual distribution. For example, the alignment execution unit 13 subtracts the residual from the coordinates of the marker MK so that each marker MK accurately rides on the face model FM. The alignment execution unit 13 subtracts residuals from the coordinates of the marker MK for other than the frame used for alignment. The alignment execution unit 13 outputs the corrected position information of the plurality of markers MK as corrected position information CI.

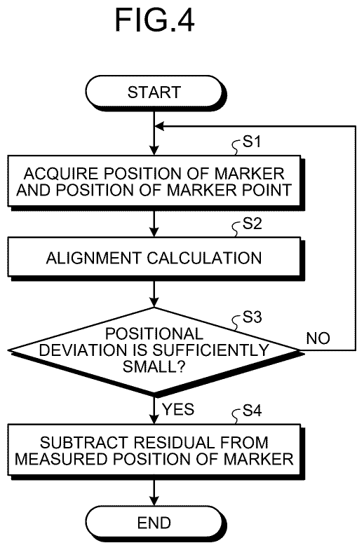

FIG. 4 is a diagram illustrating an example of a processing flow of alignment processing.

The alignment execution unit 13 acquires the positions of the plurality of markers MK from the marker position acquisition unit 11. Further, the alignment execution unit 13 acquires the positions of the plurality of marker points MP from the face model FM (step S1). The alignment execution unit 13 aligns the plurality of markers MK with the face model FM based on the position information of each marker MK and each marker point MP (step S2).

The alignment execution unit 13 calculates a positional deviation between the corresponding marker MK and the marker point MP. The alignment execution unit 13 acquires the magnitude of the positional deviation as a residual, and determines whether the total residual is sufficiently small for all the markers MK (step S3). For example, when the total residual is equal to or less than the reference value, it is determined that the positional deviation is sufficiently small. When the total residual is larger than the reference value, it is determined that the positional deviation is large. The reference value indicates an allowable range of the positional deviation. The reference value is arbitrarily set by the system developer.

In a case where the positional deviation is sufficiently small (step S3: Yes), the alignment execution unit 13 ends the alignment and acquires the distribution of the positional deviation between each marker MK and the face model FM as the residual distribution. The alignment execution unit 13 subtracts the residual from the measured position of the marker MK for each marker MK based on the residual distribution (step S4). The alignment execution unit 13 outputs the position information of each marker MK corrected by the subtraction as the corrected position information CI.

In a case where the positional deviation is large (step S3: No), the process returns to step S1. The alignment execution unit 13 changes the translation amount and the rotation amount of the face model FM and repeats the above-described alignment until the positional deviation becomes sufficiently small.

### [1-4. First Deformation Execution Unit]

The first deformation execution unit 14 specifies the positions of the plurality of markers MK attached to the face of the actor AC based on the corrected position information CI. In the corrected position information CI, positions (corrected positions) of the plurality of markers MK after correction obtained by correcting the measured positions of the plurality of markers MK based on the residual distribution are defined. The first deformation execution unit 14 deforms the face model FM of the actor AC based on the positions of the plurality of markers MK defined in the corrected position information CI, and generates the first deformed face model DM1 (first deformation processing).

For example, an algorithm called Linear Shell Deformation (LSD) is used for the deformation processing. The LSD is an algorithm that gives a plausible deformation to a shape constituted by polygon mesh. In the LSD, some vertices u_{H} of the polygon mesh are used as control points, and the remaining vertices are entirely deformed. The deformation is performed by minimization of the following Formula (1). Here, u represents all vertices of the polygon mesh, and Δ represents a Laplacian Beltrami Operator.

$$- {k}_{s} Δ u + {k}_{b} {Δ}^{2} u = 0 , \qquad ( 1 )$$

The LSD is obtained by formulating deformation of a polygon mesh with parameters of “Stretching” and “Bending”. The term relating to kₛ is a penalty for Stretching. The term relating to ko is a penalty for Bending. In the LSD, it is possible to perform deformation imitating various objects by adjusting the values of these two variables. When a large value is put in kₛ and Formula (1) is solved, a deformation result as in a case where a hard object is deformed can be obtained. When a large value is put in k_{b} and Formula (1) is solved, a deformation result as if a soft object is deformed can be obtained.

The first deformation execution unit 14 acquires the position of each marker MK defined in the corrected position information CI as the position of each marker point MP. The first deformation execution unit 14 detects the displacement of the marker point MP from the initial position for each marker point MP. The initial position is the position (for example, the position of the marker point MP at the time of being expressionless) of the marker point MP registered in the face model FM. The first deformation execution unit 14 uses each marker point MP as a control point, and deforms the entire face by LSD on the basis of the displacement of each marker point MP from the initial position.

### [1-5. Second Deformation Execution Unit]

The second deformation execution unit 15 deforms the shape of the low reproduction portion of the first deformed face model DM1 based on the contour position information CP acquired from the contour position detection unit 12 (second deformation processing). The second deformation execution unit 15 deforms the shape of the low reproduction portion of the first deformed face model DM1 based on the face image IM of the actor AC so that the position of the contour CN of the low reproduction portion having relatively low reproducibility in the first deformed face model DM1 matches the position of the contour CN of the low reproduction portion in the face image IM of the actor AC, and generates a second deformed face model DM2.

The deformation processing is realized by minimizing a projection error between the position of the contour CN detected from the face image IM and the vertex group of the polygon mesh corresponding to the position of the contour CN defined in the face model FM in advance. The minimization of the projection error is realized by minimizing a function E including five cost functions defined in the following Formula (2).

$$E = {λ}_{cont} {E}_{cont} + {λ}_{reg} {E}_{reg} + {λ}_{bnd} {E}_{fix} + {λ}_{lnd} {E}_{fix} + {λ}_{sph} {E}_{sph} \qquad ( 2 )$$

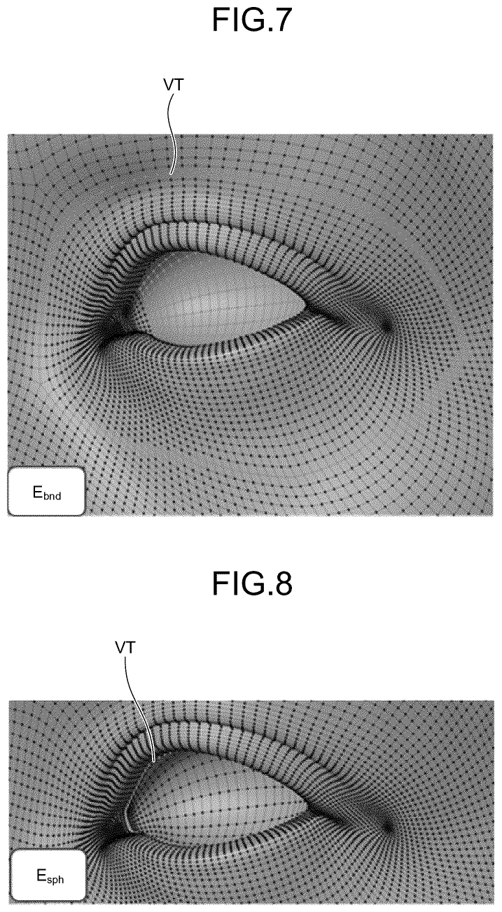

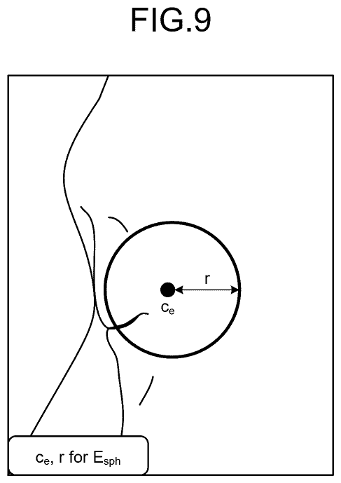

FIGS. 5 to 9 are diagrams illustrating examples of regions on the face model FM to be a target of cost calculation. In the examples of FIGS. 5 to 9, the low reproduction portion is the eyelid. The region in the vicinity of the eyelid is a target of deformation. The second deformation execution unit 15 sets, as a deformation target region TG, a region in the vicinity of the low reproduction portion where the marker MK is not arranged in the face image IM of the actor AC, and selectively deforms the shape of the first deformed face model DM1 of the deformation target region TG. The vertexes VT to be calculated of the cost functions E_{reg}, E_{cont}, E_{bnd}, and Eₛₚₕ are defined in the face model FM in advance. FIGS. 5 to 9 illustrate examples of the definition.

The first function E_{cont} of Formula (2) represents the cost of the deviation between the vertex VT of the polygon mesh and the contour CN in the face image IM. The function E_{cont} is defined as the following Formula (3).

$${E}_{cont} = {\sum }_{p} {‖ {c}_{p} - π ( {v}_{p}^{′} ) ‖}_{2}^{2} \qquad ( 3 )$$

In Formula (3), v′ₚ is a coordinate of the p-th vertex VT corresponding to the contour CN on the polygon mesh. π is a function for projecting v′ onto the camera coordinate plane. cₚ is the position of the pixel closest to π (V′ₚ) in the pixel group of the contour CN in the face image IM.

The second function E_{reg} of Formula (2) is a regularization term using the Laplacian Beltrami Operator. The function E_{reg} is defined as the following Formula (4).

$${E}_{reg} = {\sum }_{i ∈ V} {‖ Δ ( {v}_{i}^{′} - {v}_{i} ) ‖}_{2}^{2} \qquad ( 4 )$$

Δ in Formula (4) is Laplacian Beltrami Operator. V is the entire vertex of the region (deformation target region TG) in the vicinity of the low reproduction portion to be deformed. v is a coordinate of the vertex VT before deformation of V. v′ is a coordinate of the vertex VT after deformation.

The third function E_{fix} of Formula (2) is a cost function for fixing the vertex VT. The function E_{fix} is defined as a point-to-point error function as in the following Formula (5).

$${E}_{fix} = {\sum }_{b} {‖ {v}_{b}^{′} - {v}_{b} ‖}_{2}^{2} \qquad ( 5 )$$

The function E_{fix} is used to smooth the joining between the deformation target region TG and a region (fixed region) other than the deformation target region TG. The fixed region is a region in which the coordinates of the vertex VT are determined based on the corrected position information CI of the marker MK. Since the coordinates directly obtained from the marker MK are highly reliable, they may be excluded from the target of the deformation processing by the second deformation execution unit 15 (deformation processing based on the contour CN of the low reproduction portion).

By designating the function E_{fix} at the end of the deformation target region TG, the position of the end of the deformation target region TG can be maintained at the original position (position calculated based on the marker MK). Since the position of the marker MK is a position detected from the actual motion of the face of the actor AC, this term is used so that the position does not move when the shape of the low reproduction portion is deformed. By fixing the position of the end of the deformation target region TG, the deformation target region TG and the fixed region can be smoothly connected even if the shape of the deformation target region TG changes.

The last function Eₛₚₕ of Formula (2) is a cost function for grounding the eyelid and the eyeball. The cost function Eₛₚₕ is defined as the following Formula (6) by approximating the eyeball model with a sphere.

$${E}_{sph} = {\sum }_{s} {( {\vert {v}_{s}^{′} - {c}_{e} \vert}^{2} - {r}^{2} )}^{2} \qquad ( 6 )$$

In Formula (6), Ce represents the center coordinates of the eyeball. r is a radius of the eyeball. In the shape correction using the contour CN, the vertex VT on the polygon mesh is projected on the camera image plane, and the deformation is realized so as to match the contour CN. However, in this correction, since the three-dimensional information is insufficient, the shape of the deformed eyelid may interfere with the eyeball. The second deformation execution unit 15 deforms the shape of the eyelid of the first deformed face model DM1 so as to be matched with the position of the eyeball defined in advance with respect to the face model FM. The function Eₛₚₕ is effective for avoiding interference between the eyeball and the eyelid and reproducing a more accurate eyelid shape.

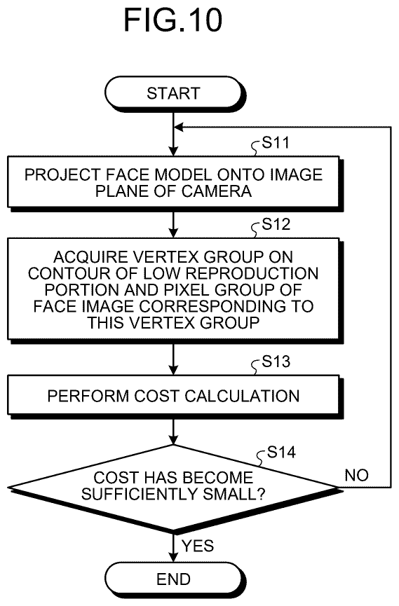

FIG. 10 is a diagram illustrating an example of a processing flow of the second deformation processing.

The second deformation execution unit 15 projects the face model FM onto the image plane of the camera 30 (step S11). The second deformation execution unit 15 acquires a vertex group (contour vertex group) of the face model FM located on the contour CN of the low reproduction portion and a pixel group (contour pixel group) of the face image IM corresponding to the contour vertex group (step S12). The second deformation execution unit 15 performs cost calculation based on Formula (2) (step S13).

The second deformation execution unit 15 determines whether the cost calculated by Formula (2) has become sufficiently small (step S14). The second deformation execution unit 15 determines that the cost has become sufficiently small when the cost is equal to or less than the allowable value. The allowable value is arbitrarily set by the system developer.

When the cost has become sufficiently small (step S14: Yes), the second deformation execution unit 15 ends the deformation processing and outputs the deformed first deformed face model DM1 as the second deformed face model DM2. In a case where the cost is not sufficiently small (step S14: No), the process returns to step S11. The second deformation execution unit 15 repeats the above-described processing until the cost becomes sufficiently small.

### [1-6. Third Deformation Execution Unit]

The third deformation execution unit 16 performs deformation processing reflecting the individuality of the actor AC in the second deformed face model DM2 to generate a third deformed face model DM3 (third deformation processing). For example, an algorithm called Weighted Pose Space Deformation (WPSD) is used for the deformation processing. In order to reflect the individuality of the actor AC, preliminary learning using a plurality of Examples and generation processing using learning data are performed.

The generation processing is required to correct the residual between the second deformed face model DM2 and the true value. In order to achieve this, the third deformation execution unit 16 estimates an error from the true value using Radius Basis Function (RBF) function interpolation. An expression Example acquired in advance is used to learn the weight of the RBF function interpolation. According to the experiments of the present inventor, it is known that Facial Animation with high quality can be realized by using about 10 types of expression data in which the face is greatly moved as the expression Example.

In the learning, first, for each expression Example, a pair of the second deformed face model DM2 and Ground Truth is prepared as learning data. Ground Truth serving as teacher data is mesh data MD (see FIG. 11) of an actor AC representing a plurality of expressions prepared in advance as Examples. The second deformed face model DM2 to be student data is generated by deforming the face model FM of the actor AC in accordance with the expression of Ground Truth. The third deformation execution unit 16 performs the deformation processing using the correction model corrected by the RBF function interpolation using the student data acquired from the second deformed face model DM2 and the teacher data acquired from the plurality of pieces of mesh data MD of the actor AC prepared in advance as Examples.

In the conventional method described in Document 3 below, processing of deforming the face model FM by LSD is performed using the coordinates of the vertex VT on which the marker MK is installed as a control point. With this processing, the deformed face model to be the student data is generated. In this method, since the deformed face model is generated based on only the marker MK, there is a possibility that a deviation occurs between the teacher data and the student data and appropriate learning is not performed.
[Document 3] “Pose-Space Animation and Transfer of Facial Details”, SCA′ 08: Proceedings of the 2008 Eurographics/ACM SIGGRAPH Symposium on Computer Animation, 2008

In the present disclosure, as the deformation processing of the face model FM, second deformation processing and third deformation processing are performed in addition to the first deformation processing. Since the student data accurately reproduced up to the low reproduction portion is generated, it is easy to perform appropriate learning as compared with the conventional method of Document 3.

For example, in addition to the vertex VT (marker point MP) at which the marker MK is installed, the third deformation execution unit 16 uses the vertex VT on the contour CN of the low reproduction portion as the control point CT (see FIG. 11). The third deformation execution unit 16 performs the first deformation processing on the face model FM based on the displacement of the control point CT. The third deformation execution unit 16 outputs the face model FM after the first deformation processing thus obtained as student data. As a result, it is possible to impart deformation imitating the shape change of the low reproduction portion to the student data.

FIG. 11 is a diagram illustrating a generation example of learning data.

On the left side of FIG. 11, an example of the face model FM and the control point CT for generating learning data is illustrated. In the example of FIG. 11, the marker point MP and the vertex AV on the contour CN of the eyelid are illustrated as the control point CT. The mesh data MD of the actor AC serving as the teacher data (Ground Truth) is illustrated in the central portion of FIG. 11. The right end of FIG. 11 illustrates a second deformed face model DM2 serving as the student data.

The mesh data MD used as teacher data in the WPSD represents about 10 types of expressions prepared in advance, and accurately indicates the shape of the face of the actor AC. For example, the actor AC has a double eyelid, and a wrinkle shape indicating the double eyelid is imparted to the face model FM of the actor AC (see the left end in FIG. 11).

In FIG. 11, the mesh data MD used as the teacher data indicates a state in which the actor AC closes its eyes. When the face model FM is deformed in accordance with the teacher data, since the vertex VT on the contour CN of the eyelid is used as the control point CT, even the shape of the eye area is accurately reproduced. However, in the first deformation processing and the second deformation processing, only the conversion of the geometric arrangement of each vertex VT is performed, and thus, processing of extending wrinkles is not performed. Therefore, the wrinkle of the double eyelid that should disappear when the eye is closed remains as the error portion ER in the second deformed face model DM2 (see the right end of FIG. 11). The third deformation execution unit 16 corrects the error portion ER caused by the individuality of the actor AC on the basis of machine learning.

The third deformation execution unit 16 outputs a residual from the true value with respect to the input by using RBF function interpolation. The output of the residual by the RBF function interpolation is performed by the following Formula (7).

$${d}_{v} ( f ) = {{\sum }_{j = 1}}^{P} {w}_{v , j} φ ( {‖ f - {f}_{j} ‖}_{v} ) \qquad ( 7 )$$

dᵥ(f) in Formula (7) is a residual with respect to the vertex v. f is a feature amount calculated from the input mesh (polygon mesh of the second deformed face model DM2). For example, the third deformation execution unit 16 uses the Feature Graph as the feature amount f of the input mesh. FIG. 12 is a diagram illustrating an example of a Feature Graph.

In the conventional method of Document 3, the position of the marker MK (marker point MP) is set as the node ND of the Feature Graph, and the feature amount is calculated from the expansion information of the edge EG connecting the nodes ND. The feature amount f=[f₁, . . . , f_{F}]^{T} is calculated from the following Formula (8).

$${f}_{i} = \frac{‖ {p}_{i , 1} - {p}_{i , 2} ‖ - {l}_{i}}{{l}_{i}} \qquad ( 8 )$$

$${p}_{i , 1} , {p}_{i , 2} ∈ {ℝ}^{3}$$

f in Formula (7) is a feature amount calculated from the input mesh. fⱼ in Formula (8) is a feature amount in the j-th learning data. The RBF function interpolation is expressed as the distance between the input f and the P pieces of learning data fⱼ calculated by the weighted sum using the weight w_{v,j}. The weight w_{v,j} is a value learned in advance using the expression Example. Note that φ(r)=r. The third deformation execution unit 16 improves the robustness by weighting the distance of the feature amount between the input and the learning data with the distance from the vertex.

The difference value of the feature amount is defined as the following Formula (9).

$${‖ f - {f}_{j} ‖}_{v} = {( {{\sum }_{i = 1}}^{F} {{α}_{v , i} ( {f}_{i} - {f}_{j , i} )}^{2} )}^{\frac{1}{2}} \qquad ( 9 )$$

$${α}_{v , i} = \frac{{\overline{α}}_{v , i}}{{\sum }_{i} {\overline{α}}_{v , i}}$$

$${\overline{α}}_{v , i} = exp ( - β ( {L}_{v , i} - {l}_{i} ) )$$

As described above, in the conventional method of Document 3, the marker MK is treated as the node ND of the Feature Graph. In the present disclosure, it is assumed that the marker MK does not exist on the eyelid. In that case, the deformation of the eyelid shape is not reflected as an input. Therefore, in the present disclosure, by adding a virtual node ND (virtual node AN) to the end of the eyelid, the deformation of the eyelid shape is reflected as an input (see the left diagram in FIG. 12).

For example, the third deformation execution unit 16 acquires the individual markers MK as the nodes ND, and sets one or more virtual nodes ND in the low reproduction portion of the second deformed face model DM2. The third deformation execution unit 16 performs deformation processing in which the characteristics of the individual edges EG connecting the nodes ND are reflected as individuality.

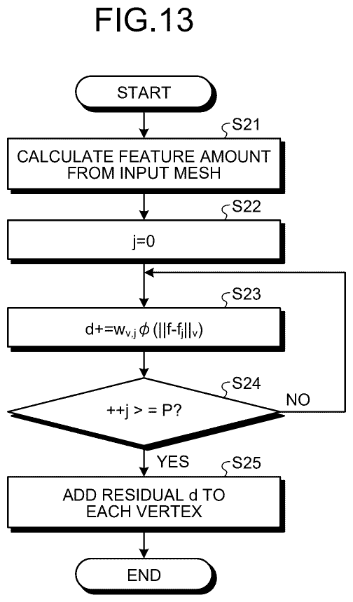

FIG. 13 is a diagram illustrating an example of a processing flow of the third deformation processing.

The third deformation execution unit 16 calculates the feature amount of the input mesh using the Feature Graph (step S21). The third deformation execution unit 16 calculates a residual d by the RBF function interpolation based on Formula (7) (steps S22 to S24). The third deformation execution unit 16 adds the residual d to each vertex VT (step S25).

### 2. Processing Example

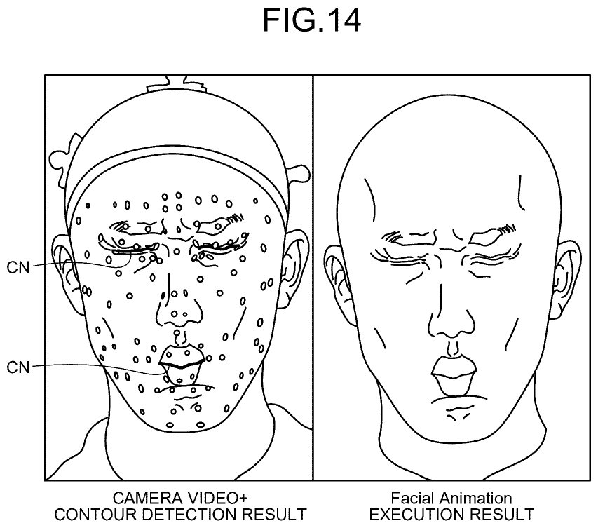

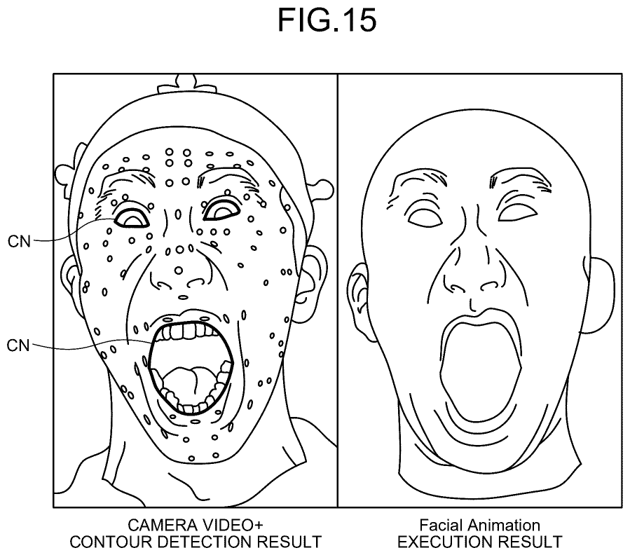

FIGS. 14 and 15 are diagrams illustrating processing examples.

In the examples of FIGS. 14 and 15, the contours of the eyelid and the mouth are detected as the contour CN of the low reproduction portion. In the example of FIG. 14, the actor AC strongly closes its eyes and makes its mouth pointed. In the example of FIG. 15, the actor AC widely opens its eyes and widely opens its mouth. In both examples, deformation of the eye area and the mouth area is accurately reproduced.

### 3. Hardware Configuration Example

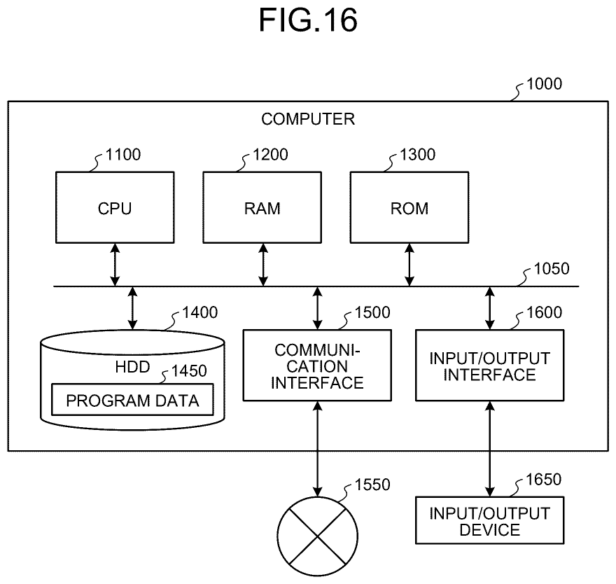

FIG. 16 is a diagram illustrating an example of a hardware configuration of the information processing apparatus 10.

The information processing of the information processing apparatus 10 is realized by, for example, a computer 1000. The computer 1000 includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program (program data 1450) stored in the ROM 1300 or the HDD 1400, and controls each unit. For example, the CPU 1100 develops the program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a non-transitory computer-readable recording medium that non-transiently records a program executed by the CPU 1100, data used by the program, and the like. Specifically, the HDD 1400 is a recording medium that records the information processing program according to the embodiment as an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display device, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 10 according to the embodiment, the CPU 1100 of the computer 1000 implements the functions of the above-described units by executing the information processing program loaded on the RAM 1200. In addition, the HDD 1400 stores an information processing program, various models, and various data according to the present disclosure. Note that the CPU 1100 reads the program data 1450 from the HDD 1400 and executes the program data, but as another example, these programs may be acquired from another device via the external network 1550.

### 4. Effects

The information processing apparatus 10 includes the first deformation execution unit 14 and the second deformation execution unit 15. The first deformation execution unit 14 deforms the face model FM of the actor AC based on the positions of the plurality of markers MK in the face image IM of the actor AC to which the plurality of markers MK are attached, and generates the first deformed face model DM1. The second deformation execution unit 15 deforms the shape of the low reproduction portion of the first deformed face model DM1 based on the face image IM of the actor AC so that the position of the contour CN of the low reproduction portion having relatively low reproducibility in the first deformed face model DM1 matches the position of the contour CN of the low reproduction portion in the face image IM of the actor AC, and generates the second deformed face model DM2. In the information processing method of the present disclosure, the processing of the information processing apparatus 10 is executed by the computer 1000. The computer-readable non-transitory storage medium of the present disclosure stores a program for causing the computer 1000 to implement processing of the information processing apparatus 10.

According to this configuration, the face model FM is deformed based on not only the position information of the marker MK attached to the face of the actor AC but also the position information of the contour CN of the low reproduction portion extracted from the face image IM. Therefore, the motion of the face of the actor AC is reproduced with high quality.

The information processing apparatus 10 includes a contour position detection unit 12. The contour position detection unit 12 specifies the position of the contour CN of the low reproduction portion in the face image IM of the actor AC based on the positions of one or more landmarks extracted from the face image IM of the actor AC.

According to this configuration, the position of the contour CN of the low reproduction portion is accurately specified.

The information processing apparatus 10 includes an alignment execution unit 13. The alignment execution unit 13 aligns the plurality of markers MK with respect to the face model FM, and acquires a distribution of the positional deviation between each marker MK and the face model FM as a residual distribution. The first deformation execution unit 14 deforms the face model FM based on the positions of the plurality of markers MK corrected based on the residual distribution.

According to this configuration, the plurality of markers MK are well positioned with respect to the face model FM. Therefore, the motion of the face can be accurately converted into the relative motion between the markers MK.

The second deformation execution unit 15 sets, as the deformation target region TG, a region in the vicinity of the low reproduction portion where the marker MK is not arranged in the face image IM of the actor AC. The second deformation execution unit 15 selectively deforms the shape of the first deformed face model DM1 in the deformation target region TG.

According to this configuration, it is possible to selectively correct only the shape of the deformation target region TG in which sufficient reproducibility cannot be obtained only with the marker MK while maintaining the shape of the portion appropriately deformed based on the marker MK.

The low reproduction portion is the eyelid.

According to this configuration, the reproducibility of the eyelid is enhanced. Eyes are important elements for emotional expression. In order to detect eye motion, it is necessary to attach the marker MK to the eyelid. However, since the eyelid is small, it is difficult to attach the marker MK. Even if the marker MK can be attached, the marker MK may be hidden by opening and closing of the eyelid. When the eyelid is deformed based on the feature analysis of the face image IM as in the present disclosure, the shape of the eyelid can be accurately reproduced without depending on the marker MK. Therefore, delicate feeling can be expressed by eye motion.

The second deformation execution unit 15 deforms the shape of the eyelid of the first deformed face model DM1 so as to be matched with the position of the eyeball set in advance in the face model FM of the actor AC.

According to this configuration, the eyelid can be appropriately deformed along the eyeball.

The information processing apparatus 10 includes the third deformation execution unit 16. The third deformation execution unit 16 performs deformation processing reflecting the individuality of the actor AC in the second deformed face model DM2 to generate the third deformed face model DM3.

According to this configuration, the deformed face model reflecting the individuality of the actor AC is generated.

The third deformation execution unit 16 performs the deformation processing using the correction model in which the learning is performed using the student data acquired from the second deformed face model DM2 and the teacher data including the plurality of pieces of mesh data MD representing the facial expressions of the actor AC.

According to this configuration, high-quality student data accurately reproduced up to the low reproduction portion is used for learning of the correction model. Since the accuracy of learning is enhanced, appropriate deformation processing is performed.

The third deformation execution unit 16 acquires each marker MK as a node, and sets one or more virtual nodes ND in the low reproduction portion of the second deformed face model DM2. The third deformation execution unit 16 performs deformation processing in which the characteristics of the individual edges EG connecting the nodes ND are reflected as individuality.

According to this configuration, the deformation processing that appropriately reflects the individuality of the actor AC is performed.

Note that the effects described in the present specification are merely examples and are not limited, and other effects may be provided.

### SUPPLEMENTARY NOTE

Note that the present technology can also have the following configurations.

(1)

An information processing apparatus comprising:
a first deformation execution unit that deforms a face model of an actor on a basis of positions of a plurality of markers in a face image of the actor to which the plurality of markers are attached, and generates a first deformed face model; and
a second deformation execution unit that deforms a shape of a low reproduction portion of the first deformed face model on a basis of the face image of the actor so that a position of a contour of the low reproduction portion having relatively low reproducibility in the first deformed face model matches a position of a contour of the low reproduction portion in the face image of the actor, and generates a second deformed face model.
   (2)

The information processing apparatus according to (1), further comprising
a contour position detection unit that specifies the position of the contour of the low reproduction portion in the face image of the actor on a basis of positions of one or more landmarks extracted from the face image of the actor.
   (3)

The information processing apparatus according to (1) or (2), further comprising
an alignment execution unit that aligns the plurality of markers with respect to the face model and acquires a distribution of a positional deviation between each marker and the face model as a residual distribution, wherein
the first deformation execution unit deforms the face model on a basis of the positions of the plurality of markers corrected based on the residual distribution.
   (4)

The information processing apparatus according to any one of (1) to (3), wherein
the second deformation execution unit sets a region in the vicinity of the low reproduction portion where no marker is arranged in the face image of the actor as a deformation target region, and selectively deforms the shape of the first deformed face model in the deformation target region.
   (5)

The information processing apparatus according to any one of (1) to (4), wherein
the low reproduction portion is an eyelid.
   (6)

The information processing apparatus according to (5), in which
the second deformation execution unit deforms the shape of the eyelid of the first deformed face model so as to be matched with the position of the eyeball specified based on the positions of the plurality of markers.
   (7)

The information processing apparatus according to any one of (1) to (6), further comprising
a third deformation execution unit that performs deformation processing reflecting individuality of the actor on the second deformed face model and generates a third deformed face model.
   (8)

The information processing apparatus according to (7), wherein
the third deformation execution unit performs the deformation processing using a correction model in which learning is performed using student data acquired from the second deformed face model and teacher data including a plurality of pieces of mesh data representing facial expressions of the actor.
   (9)

The information processing apparatus according to (7) or (8), wherein
the third deformation execution unit acquires each marker as a node, sets one or more virtual nodes in the low reproduction portion of the second deformed face model, and performs deformation processing in which a feature of each edge connecting nodes is reflected as the individuality.
   (10)

An information processing method executed by a computer, the method comprising:
deforming a face model of an actor on a basis of positions of a plurality of markers in a face image of the actor to which the plurality of markers are attached, and generating a first deformed face model; and
deforming a shape of a low reproduction portion of the first deformed face model on a basis of the face image of the actor so that a position of a contour of the low reproduction portion having relatively low reproducibility in the first deformed face model matches a position of a contour of the low reproduction portion in the face image of the actor, and generating a second deformed face model.
   (11)

A computer-readable non-transitory storage medium storing a program for causing a computer to execute:
deforming a face model of an actor on a basis of positions of a plurality of markers in a face image of the actor to which the plurality of markers are attached, and generating a first deformed face model; and
deforming a shape of a low reproduction portion of the first deformed face model on a basis of the face image of the actor so that a position of a contour of the low reproduction portion having relatively low reproducibility in the first deformed face model matches a position of a contour of the low reproduction portion in the face image of the actor, and generating a second deformed face model.

### REFERENCE SIGNS LIST

10 INFORMATION PROCESSING APPARATUS
12 CONTOUR POSITION DETECTION UNIT
13 ALIGNMENT EXECUTION UNIT
14 FIRST DEFORMATION EXECUTION UNIT
15 SECOND DEFORMATION EXECUTION UNIT
16 THIRD DEFORMATION EXECUTION UNIT
AC ACTOR
CN CONTOUR
DM1 FIRST DEFORMED FACE MODEL
DM2 SECOND DEFORMED FACE MODEL
DM3 THIRD DEFORMED FACE MODEL
FM FACE MODEL
IM FACE IMAGE
MK MARKER
ND NODE
TG DEFORMATION TARGET REGION

What is claimed is:

1. An information processing apparatus comprising:
a first deformation execution unit that deforms a face model of an actor on a basis of positions of a plurality of markers in a face image of the actor to which the plurality of markers are attached, and generates a first deformed face model; and
a second deformation execution unit that deforms a shape of a low reproduction portion of the first deformed face model on a basis of the face image of the actor so that a position of a contour of the low reproduction portion having relatively low reproducibility in the first deformed face model matches a position of a contour of the low reproduction portion in the face image of the actor, and generates a second deformed face model.

2. The information processing apparatus according to claim 1, further comprising
a contour position detection unit that specifies the position of the contour of the low reproduction portion in the face image of the actor on a basis of positions of one or more landmarks extracted from the face image of the actor.

3. The information processing apparatus according to claim 1, further comprising
an alignment execution unit that aligns the plurality of markers with respect to the face model and acquires a distribution of a positional deviation between each marker and the face model as a residual distribution, wherein
the first deformation execution unit deforms the face model on a basis of the positions of the plurality of markers corrected based on the residual distribution.

4. The information processing apparatus according to claim 1, wherein
the second deformation execution unit sets a region in the vicinity of the low reproduction portion where no marker is arranged in the face image of the actor as a deformation target region, and selectively deforms the shape of the first deformed face model in the deformation target region.

5. The information processing apparatus according to claim 1, wherein
the low reproduction portion is an eyelid.

6. The information processing apparatus according to claim 5, wherein
the second deformation execution unit deforms a shape of the eyelid of the first deformed face model so as to be matched with a position of an eyeball set in advance in the face model of the actor.

7. The information processing apparatus according to claim 1, further comprising
a third deformation execution unit that performs deformation processing reflecting individuality of the actor on the second deformed face model and generates a third deformed face model.

8. The information processing apparatus according to claim 7, wherein
the third deformation execution unit performs the deformation processing using a correction model in which learning is performed using student data acquired from the second deformed face model and teacher data including a plurality of pieces of mesh data representing facial expressions of the actor.

9. The information processing apparatus according to claim 7, wherein
the third deformation execution unit acquires each marker as a node, sets one or more virtual nodes in the low reproduction portion of the second deformed face model, and performs deformation processing in which a feature of each edge connecting nodes is reflected as the individuality.

10. An information processing method executed by a computer, the method comprising:
deforming a face model of an actor on a basis of positions of a plurality of markers in a face image of the actor to which the plurality of markers are attached, and generating a first deformed face model; and
deforming a shape of a low reproduction portion of the first deformed face model on a basis of the face image of the actor so that a position of a contour of the low reproduction portion having relatively low reproducibility in the first deformed face model matches a position of a contour of the low reproduction portion in the face image of the actor, and generating a second deformed face model.

11. A computer-readable non-transitory storage medium storing a program for causing a computer to execute:
deforming a face model of an actor on a basis of positions of a plurality of markers in a face image of the actor to which the plurality of markers are attached, and generating a first deformed face model; and
deforming a shape of a low reproduction portion of the first deformed face model on a basis of the face image of the actor so that a position of a contour of the low reproduction portion having relatively low reproducibility in the first deformed face model matches a position of a contour of the low reproduction portion in the face image of the actor, and generating a second deformed face model.
